(19) United States
(12) Patent Application Publication
(10) Pub. No.: US 2013/0176983 A1
(43) Pub. Date: Jul. 11, 2013

(54) METHOD FOR RESOURCE SCHEDULING USING A CARRIER AGGREGATION TECHNIQUE

(71) Applicants: Manyoung Jung, Anyang-si (KR); Suhwan Lim, Anyang-si (KR); Yoonoh Yang, Anyang-si (KR); Sangwook Lee, Anyang-si (KR)

(72) Inventors: Manyoung Jung, Anyang-si (KR); Suhwan Lim, Anyang-si (KR); Yoonoh Yang, Anyang-si (KR); Sangwook Lee, Anyang-si (KR)

(73) Assignee: LG ELECTRONICS INC., Seoul (KR)

(21) Appl. No.: 13/824,301

(22) PCT Filed: Jul. 29, 2011
(86) PCT No.: PCT/KR11/05606

§ 371 Date: Mar. 15, 2013

Related U.S. Application Data
(60) Provisional application No. 61/383,736, filed on Sep. 17, 2010.

(30) Foreign Application Priority Data
Feb. 23, 2011 (KR) 10-2011-0016198

(51) Int. Cl. H04W 52/36

(52) U.S. Cl. CPC H04W 52/365
USPC 370/329

(57) ABSTRACT

Provided is a scheduling method for allocating a discontinuous resource to a user equipment by using carrier aggregation. The scheduling method includes: receiving a power headroom report from the user equipment; determining discontinuous resource blocks to be allocated to the user equipment on the basis of the power headroom report among the remaining unallocated resource blocks, wherein the determined discontinuous resource blocks suppress occurrence of unnecessary emission; and allocating the determined discontinuous resource blocks to the user equipment.

### TECHNICAL FIELD

The present invention relates to scheduling in a carrier aggregation technique.

### BACKGROUND ART

3rd generation partnership project (3GPP) wireless communication systems based on a wideband code division multiple access (WCDMA) radio access technology are widely spread all over the world. High-speed downlink packet access (HSDPA) that can be defined as a first evolutionary stage of WCDMA provides 3GPP with a radio access technique that is highly competitive in the mid-term future.

Evolved-universal mobile telecommunications system (E-UMTS) is for providing high competitiveness in the long-term future. The E-UMTS is a system evolved from the conventional WCDMA UMTS, and its standardization work is ongoing in 3GPP. The E-UMTS is also called a long term evolution (LTE) system. Details of technical specifications of the UMTS and the E-UMTS may be found respectively in Release 7 and Release 8 of “3rd Generation Partnership Project; Technical Specification Group Radio Access Network”.

The E-UMTS consists of a user equipment (UE), a base station (BS), and an access gateway (AG) located in an end node of a network (i.e., E-UTRAN) and connected to an external network. In general, the BS can simultaneously transmit and receive multiple data streams for a broadcast service, a multicast service, and/or a unicast service. A LTE system uses orthogonal frequency divisional multiplexing (OFDM) and multi-input multi-output (MIMO) to transmit various services in a downlink.

The OFDM represents a high-speed data downlink access system. Advantageously, the OFDM has high spectrum efficiency in which an allocated spectrum can be entirely used by all BSs. In OFDM modulation, a transmission band is divided into a plurality of orthogonal subcarriers in a frequency domain and a plurality of symbols in a time domain. Since the transmission band is split into a plurality of subcarriers in the OFDM, a per-subcarrier bandwidth is decreased and a per-carrier modulation time is increased. Since the plurality of subcarriers are transmitted in parallel, a transfer rate of a symbol or digital data of a specific subcarrier is lower than that of a single carrier.

In the OFDM, a serially input data symbol is converted into N parallel data symbols, and is then transmitted by being carried on N orthogonal subcarriers. The subcarriers maintain orthogonality in a frequency dimension. Orthogonal frequency division multiple access (OFDMA) is a multiple access scheme for achieving multiple access by independently providing some of available subcarriers to each user in a system using the OFDM as a modulation scheme.

A MIMO technique is the most widely used method among methods capable of increasing capacity by interworking with the OFDM.

A MIMO system is a communication system which uses a plurality of transmit (Tx)/receive (Rx) antennas.

That is, the MIMO technique uses multiple antennas in a Tx node or an Rx node of a wireless communication system to increase capacity or to improve performance. Herein, the multiple antennas are called MIMO.

In summary, the MIMO technique uses a technique of aggregating data fragments received from several antennas to complete whole data without being dependent on a single antenna path to receive one entire message. Since a data transfer rate can be improved in a specific range or a system range can be increased with respect to a specific data transfer rate, the MIMO technique is a next-generation mobile communication technique that can be widely used for a mobile communication terminal, a relay node, etc., and is drawing attention as a next-generation technique capable of overcoming a limitation of a data transfer amount of mobile communication according to a limited situation caused by expansion of data communication, etc.

With the increase in the number of Tx/Rx antennas, the MIMO system can linearly increase channel capacity without increasing an additional frequency bandwidth. The MIMO technique employs a spatial diversity scheme capable of increasing transmission reliability by using a symbol which has passed various channel paths and a spatial multiplexing scheme which uses a plurality of Tx antennas to increase a transfer rate by transmitting separate data streams simultaneously via respective antennas.

Meanwhile, a standardization work on a carrier aggregation (CA) technique is underway in 3GPP and IEEE 802.11. The CA technique not only supports the MIMO system but also can transmit a greater amount of data to a terminal (or UE) by using different multiple carriers together. The CA technique is a technique of aggregating two or more component carriers (CCs). In LTE-A, the CA defines the CC as a basic bandwidth unit by considering backward compatibility with the conventional Rel-8 LTE system. At present, up to 100 MHz is discussed as a transmission bandwidth using up to 5 CCs in the CA technique. Accordingly, a UE supporting LTE-A can simultaneously transmit and receive a plurality of CCs supported in one LTE-A cell on the basis of capability of the UE.

The CA technique discussed in the current LTE-A specification can be roughly divided into an inter-band CA technique and an intra-band CA technique. The inter-band CA is a method of using each of CCs existing in different bands by aggregating the CCs. The intra-band CA is a method of using each of CCs existing in the same frequency band by aggregating the CCs. In addition, the CA technique is more specifically divided into intra-band contiguous CA, intra-band non-contiguous CA, and inter-band non-contiguous CA.

### SUMMARY OF INVENTION

### Technical Problem

The aforementioned carrier aggregation (CA) is proposed only in concept, and a method used to allocate carrier components to a user equipment is not proposed.

Accordingly, an object of the present invention is to provide a method of performing scheduling for the user equipment by using the CA technique.

### Technical Solution

In order to achieve the aforementioned object, according to an aspect of the present invention, there is provided a scheduling method for suppressing unwanted emission which may occur when discontinuous resources are allocated to a user equipment by using carrier aggregation.

More specifically, in order to achieve the aforementioned object, according to an aspect of the present invention, a scheduling method for allocating a discontinuous resource to a user equipment by using carrier aggregation is provided. The scheduling method includes: receiving a power headroom report from the user equipment; determining discontinuous resource blocks to be allocated to the user equipment on the basis of the power headroom report among the remaining unallocated resource blocks. Herein, the determined discontinuous resource blocks may suppress occurrence of unnecessary emission. The scheduling method may further include allocating the determined discontinuous resource blocks to the user equipment.

In the aforementioned aspect of the present invention, the determined discontinuous resource blocks may be located across a first band and a second band. The first band and the second band may be intra-bands.

In addition, in the determining of the discontinuous resource blocks, BO_{required} for using the discontinuous resource blocks may be compared with a power headroom of the user equipment.

In addition, in the determining of the discontinuous resource blocks, a power headroom of the user equipment may be compared with an amount of power to be decreased to prevent occurrence of unwanted emission when the user equipment performs transmission by using the discontinuous resource blocks.

In addition, the determined resource blocks may be resource blocks of which an amount of power to be decreased to prevent occurrence of unwanted power is less than a power headroom of the user equipment.

In addition, the amount of power to be decreased may differ depending on the number of the discontinuous resource blocks.

In addition, in the determining of the discontinuous resource blocks, a table may be used in which the amount of power to be decreased is expressed differently according to the number of the discontinuous resource blocks.

More specifically, in order to achieve the aforementioned object, according to another aspect of the present invention, a scheduling method for allocating a discontinuous resource by using carrier aggregation is provided. The scheduling method includes: selecting resource blocks to be allocated to a user equipment from among the remaining unallocated resource blocks; determining whether the selected resource blocks are discontinuous; if the selected resource blocks are discontinuous, determining whether the selected discontinuous resource blocks are suitable for the user equipment on the basis of a power headroom reported from the user equipment; and if it is determined that the selected discontinuous resource blocks are suitable for the user equipment, allocating the selected discontinuous resource blocks to the user equipment.

In the aforementioned aspect of the present invention, in the determining whether the selected discontinuous resource blocks are suitable for the user equipment, if the resource blocks are discontinuous, an amount of power to be decreased to prevent occurrence of unwanted emission may be compared with the power headroom reported from the user equipment when the user equipment performs transmission by using the discontinuous resource blocks.

### Advantageous Effects

According to an embodiment of the present invention, when discontinuous resources are allocated to a user equipment (UE), scheduling is performed by considering a possibility of occurrence of unwanted emission. Therefore, network reliability of an overall system can be improved, UE transmit (Tx) radio frequency (RF) consumption power can be decreased and costs can be decreased, without having to strengthen a UE Tx RF specification.

### DESCRIPTION OF DRAWINGS

FIG. 1 shows an antenna structure of a conventional multiple input multiple output (MIMO) system.

FIG. 2 shows the concept of intra-band carrier aggregation (CA).

FIG. 3 shows the concept of inter-band CA according to an embodiment of the present invention.

FIG. 4 shows a basic structure of a transmitter of a user equipment for each of CA supporting methods.

FIG. 5 shows a level of required power backoff in a unit of dB according to 2 cluster RB allocation in 2×20 MHz long term evolution-advanced (LTE-A) intra-band CA.

FIG. 6 is a flowchart showing a scheduling method according to an embodiment of the present invention.

FIG. 7 is a flowchart showing a scheduling method according to another embodiment of the present invention.

FIG. 8 shows a structure of a base station according to an embodiment of the present invention.

### MODE FOR INVENTION

In addition, the terminology used herein is for the purpose of describing particular embodiments only and is not intended to be limiting of the invention. Unless otherwise defined, all terms used herein have the same meaning as commonly understood by one of ordinary skill in the art to which this invention pertains, and should not be interpreted as having an excessively comprehensive meaning nor as having an excessively contracted meaning. If technical terms used herein are erroneous and thus fail to accurately express the technical idea of the present invention, it should be replaced with technical terms that allow the person in the art to properly understand. The general terms used herein should be interpreted according to the definitions in the dictionary or in the context and should not be interpreted as an excessively contracted meaning.

As used herein, the singular forms are intended to include the plural forms as well, unless the context clearly indicates otherwise. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

It is also to be noted that the suffix of constituent elements used in the following description, such as ‘module’ and ‘unit’, are simply assigned for ease of describing the invention, but are not specifically assigned according to importance and roles. Accordingly, the terms “module” and “unit” can be interchangeable.

It will be understood that although the terms “first” and “second” are used herein to describe various elements, these elements should not be limited by these terms. These terms are only used to distinguish one element from another element. For example, a first component may be termed a second component, and similarly, the second component may be termed the first component without departing from the scope of the present invention.

Hereinafter, exemplary embodiments of the present invention will be described with reference to the accompanying drawings. It is to be noted that like reference numerals denote the same components in the drawings, and a detailed description of a known structure or function of the present invention will be omitted herein if it is deemed to obscure the subject matter of the present invention.

In the following description, well-known functions or constructions are not described in detail since they would obscure the invention in unnecessary detail. The exemplary embodiments should be considered in descriptive sense only and not for purposes of limitation, and do not intend to limit technical scopes of the present invention.

Hereinafter, terms to be used in the present invention will be summarized in brief to facilitate understanding of the invention.

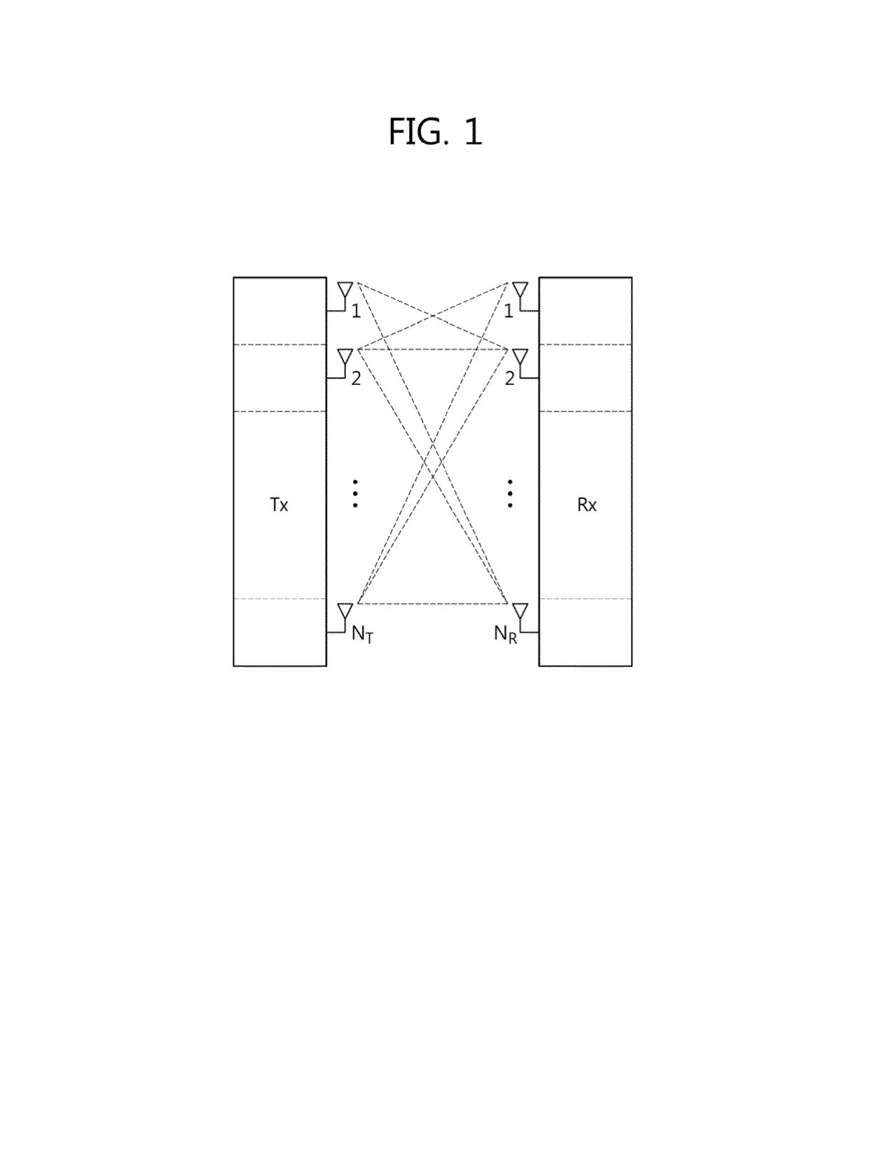

FIG. 1 shows an antenna structure of a conventional multiple input multiple output (MIMO) system.

Rᵢ=min(N_{T}, N_{R}) [Equation 1]

Research on MIMO has actively been underway up to now in various aspects such as research on an information theory related to calculation of MIMO communication capacity or the like in various channel environments and multiple access environments, research on measuring of a wireless channel of a MIMO system and modeling thereof, and research on space-time signal processing technique for improving transmission reliability and a data transfer rate.

In a structure of a user equipment (UE) having a general MIMO channel environment, a receive (Rx) signal incoming to each Rx antenna can be expressed by Equation 2 below.

$$\begin{matrix}y = [ \begin{matrix}{y}_{1} \\ {y}_{2} \\ ⋮ \\ {y}_{i} \\ ⋮ \\ {y}_{{N}_{R}}\end{matrix} ] \\ = [ \begin{matrix}{h}_{11} & {h}_{12} & … & {h}_{1 {N}_{T}} \\ {h}_{21} & {h}_{22} & … & {h}_{2 {N}_{T}} \\ ⋮ & & ⋱ & \\ {h}_{i 1} & {h}_{i 2} & … & {h}_{{iN}_{T}} \\ ⋮ & & ⋱ & \\ {h}_{{N}_{R} 1} & {h}_{{N}_{R} 2} & … & {h}_{{N}_{R} {N}_{T}}\end{matrix} ] [ \begin{matrix}{x}_{1} \\ {x}_{2} \\ ⋮ \\ {x}_{j} \\ ⋮ \\ {x}_{{N}_{T}}\end{matrix} ] + [ \begin{matrix}{n}_{1} \\ {n}_{2} \\ ⋮ \\ {n}_{i} \\ ⋮ \\ {n}_{{N}_{R}}\end{matrix} ] \\ = Hx + n\end{matrix} \qquad [ Equation 2 ]$$

Herein, a channel between each of a transmit (Tx) antenna and a receive (Rx) antenna can be identified according to a Tx/Rx antenna index. A channel passing from a Tx antenna j to an Rx antenna i is denoted by hᵢⱼ. In case of using a precoding scheme in transmission similarly to LTE, a Tx signal x can be expressed by Equation 3 below.

$$\begin{matrix}x = [ \begin{matrix}{x}_{1} \\ {x}_{2} \\ ⋮ \\ {x}_{i} \\ ⋮ \\ {x}_{{N}_{T}}\end{matrix} ] \\ = [ \begin{matrix}{w}_{11} & {w}_{12} & … & {w}_{1 {N}_{T}} \\ {w}_{21} & {w}_{22} & … & {w}_{2 {N}_{T}} \\ ⋮ & & ⋱ & \\ {w}_{i 1} & {w}_{i 2} & … & {w}_{{iN}_{T}} \\ ⋮ & & ⋱ & \\ {w}_{{N}_{T} 1} & {w}_{{N}_{T} 2} & … & {w}_{{N}_{T} {N}_{T}}\end{matrix} ] [ \begin{matrix}{\hat{s}}_{1} \\ {\hat{s}}_{2} \\ ⋮ \\ {\hat{s}}_{j} \\ ⋮ \\ {\hat{s}}_{{N}_{T}}\end{matrix} ] \\ = W \hat{s} \\ = WPs\end{matrix} \qquad [ Equation 3 ]$$

Herein, wᵢⱼ of a precoding matrix W denotes a weight between an i-th Tx antenna and j-th Tx information. In this case, if Tx power of each Tx signal is denoted by (P₁, P₂, . . . , P_{NT}), transmission information having adjusted Tx power can be expressed by a diagonal matrix P of Equation 4 below.

$$\hat{s} = [ \begin{matrix}{P}_{1} & & & 0 \\ & {P}_{2} & & \\ & & ⋱ & \\ 0 & & & {P}_{{N}_{T}}\end{matrix} ] [ \begin{matrix}{s}_{1} \\ {s}_{2} \\ ⋮ \\ {s}_{{N}_{T}}\end{matrix} ] = Ps \qquad [ Equation 4 ]$$

Meanwhile, as described above, the CA technique can be roughly divided into an inter-band CA technique and an intra-band CA technique. The inter-band CA is a method of using each of CCs existing in different bands by aggregating the CCs. The intra-band CA is a method of using each of CCs existing in the same frequency band by aggregating the CCs. In addition, the CA technique is more specifically divided into intra-band contiguous CA, intra-band non-contiguous CA, and inter-band non-contiguous CA.

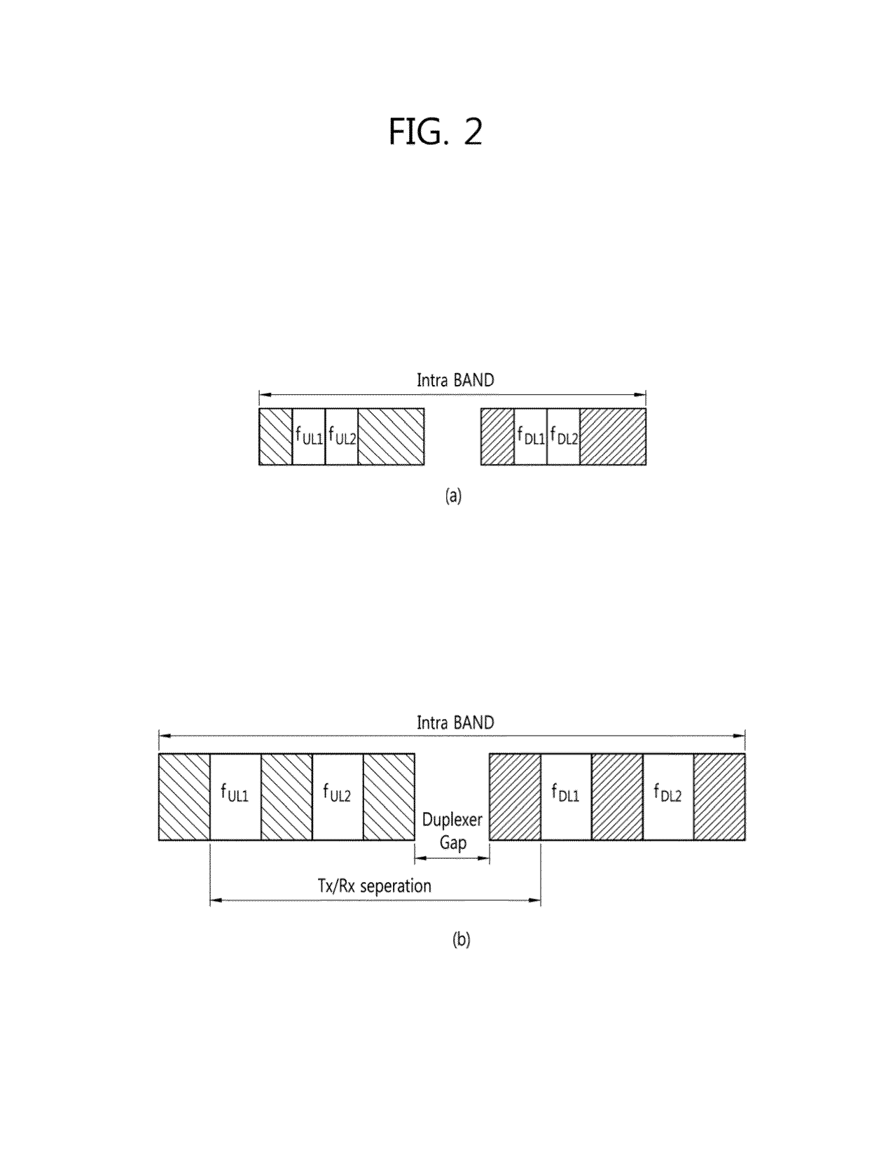

FIG. 2 shows the concept of intra-band CA. FIG. 2(a) shows intra-band contiguous CA, and FIG. 2(b) shows intra-band non-contiguous CA.

In case of LTE-Advanced, various techniques including uplink MIMO and carrier aggregation are added to implement high-speed wireless transmission. The CA discussed in LTE-Advanced can be divided into the intra-band contiguous CA shown in FIG. 2(a) and the intra-band non-contiguous CA shown in FIG. 2(b).

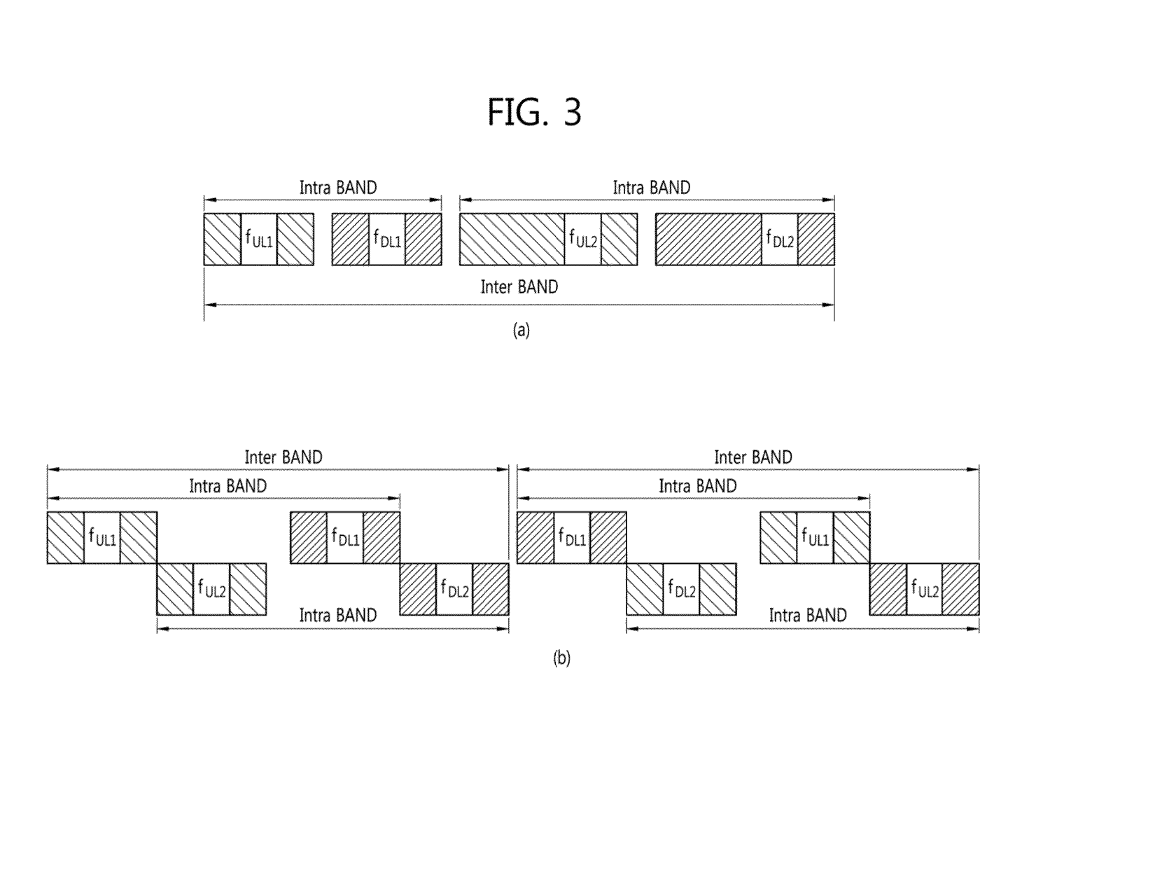

FIG. 3 shows the concept of inter-band CA according to an embodiment of the present invention. FIG. 3(a) shows a combination of a low band and a high band for the inter-band CA, and FIG. 3(b) shows a combination of similar frequency bands for the inter-band CA.

That is, the inter-band CA of FIG. 3 can be divided into inter-band CA between carriers of a low-band and a high-band when RF characteristics of the inter-band CA are different from each other as shown in FIG. 3(a) and inter-band CA of a similar frequency capable of using a common RF node for each component carrier since RF characteristics are similar as shown in FIG. 3(b).

TABLE 1

| | Uplink (UL) operating band | Downlink (DL) operating band | |
|---|---|---|---|
| E-UTRA | BS receive | BS transmit | |
| Operating | UE transmit | UE receive | Duplex |
| Band | FUL_low-FUL_high | FDL_low-FDL_high | Mode |
| 1 | 1920 MHz-1980 MHz | 2110 MHz-2170 MHz | FDD |
| 2 | 1850 MHz-1910 MHz | 1930 MHz-1990 MHz | FDD |
| 3 | 1710 MHz-1785 MHz | 1805 MHz-1880 MHz | FDD |
| 4 | 1710 MHz-1755 MHz | 2110 MHz-2155 MHz | FDD |
| 5 | 824 MHz-849 MHz | 869 MHz-894 MHz | FDD |
| 6^{Note 1} | 830 MHz-840 MHz | 875 MHz-885 MHz | FDD |
| 7 | 2500 MHz-2570 MHz | 2620 MHz-2690 MHz | FDD |
| 8 | 880 MHz-915 MHz | 925 MHz-960 MHz | FDD |
| 9 | 1749.9 MHz-1784.9 Hz | 1844.9 MHz-1879.9 Hz | FDD |
| 10 | 1710 MHz-1770 MHz | 2110 MHz-2170 MHz | FDD |
| 11 | 1427.9 MHz-1447.9 Hz | 1475.9 MHz-1495.9 MHz | FDD |
| 12 | 698 MHz-716 MHz | 728 MHz-746 MHz | FDD |
| 13 | 777 MHz-787 MHz | 746 MHz-756 MHz | FDD |
| 14 | 788 MHz-798 MHz | 758 MHz-768 MHz | FDD |
| 15 | Reserved | Reserved | FDD |
| 16 | Reserved | Reserved | FDD |
| 17 | 704 MHz-716 MHz | 734 MHz-746 MHz | FDD |
| 18 | 815 MHz-830 MHz | 860 MHz-875 MHz | FDD |
| 19 | 830 MHz-845 MHz | 875 MHz-890 MHz | FDD |
| 20 | 832 MHz 862 MHz | 791 MHz 821 MHz | FDD |
| 21 | 1447.9 MHz 1462.9 Hz | 1495.9 MHz 1510.9 Hz | FDD |
| 22 | [3410] MHz [3500] Hz | [3510] MHz [3600] MHz | FDD |
| . . . | | | |

^{Note 1}Band 6 is not applicable.

Table 1 shows operating bands defined in 3GPP TS36.101. According to the operating bands, there are four CA cases of FIG. 2 and FIG. 3.

A terminal (or UE) in LTE-Advanced or 802.11 VHT basically supports a MIMO technology, and can acquire very high data transfer rate by the use of a broadband frequency through carrier aggregation. However, the terminal supporting the CA and the MIMO system has a very complex structure, and can support them in various manners.

That is, in order to support the conventional MIMO, RF chains depending on the number of layers must be present separately. To support the CA in this structure, there are an intra-band contiguous CA supporting method and an inter-band non-contiguous CA supporting method according to a frequency owned by each of operators.

Basically, transceivers are required according to the number of component carriers (CCs) of CA that can be supported simultaneously in the architecture of the UE supporting the CA technique. However, by considering such advantages in the implementation of the UE, there is an active discussion on a single RF structure employing a broadband transceiver in case of the intra-band contiguous CA.

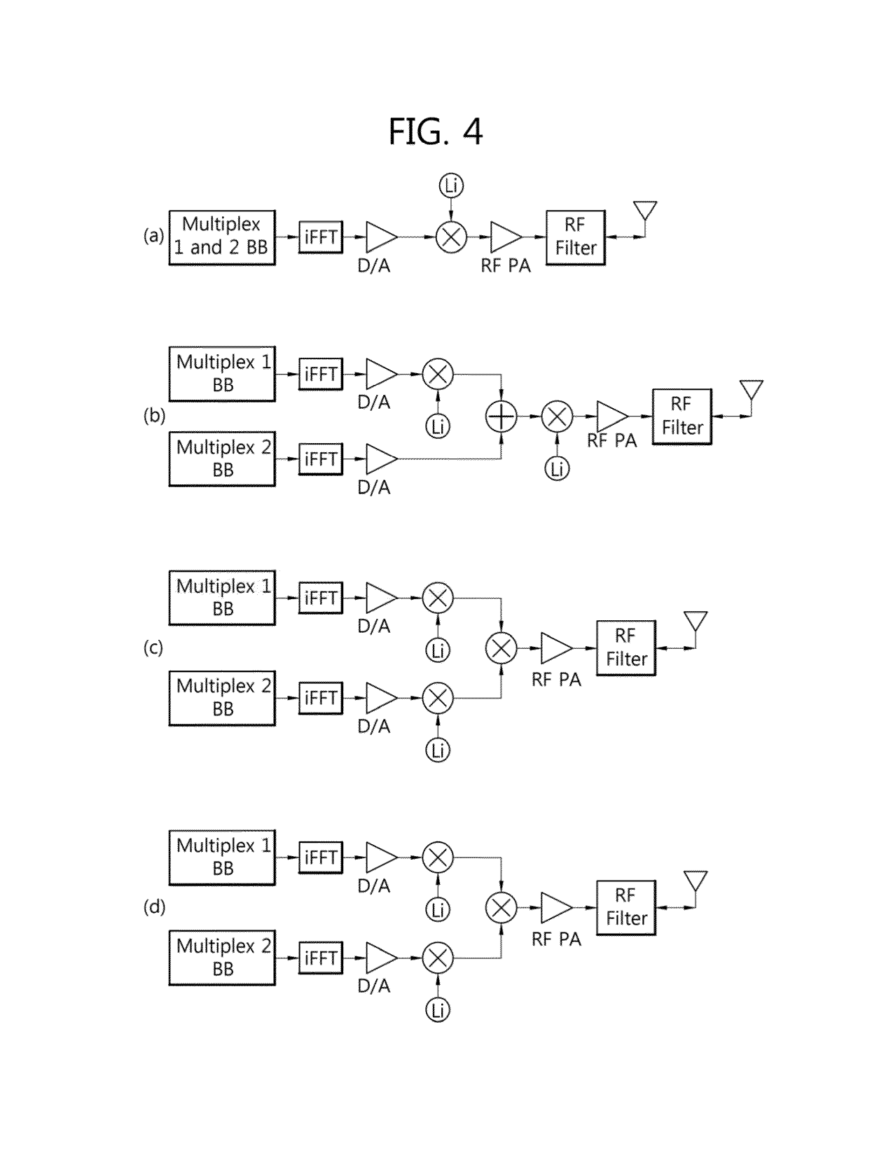

A basic structure of a transmitter of the UE for each of the CA supporting methods is shown in FIG. 4.

FIG. 4 shows a basic structure of a transmitter of a UE for each of CA supporting methods.

FIG. 4(a) shows a structure of a transmitter for intra-band contiguous CA. The transmitter includes one baseband, one inverse fast Fourier transform (IFFT) unit, one digital to analog convertor (DAC), one mixer, one power amplifier (PA), and one antenna.

FIG. 4(b) shows a structure of a transmitter supporting both the intra-band contiguous CA and the intra-band non-contiguous CA. As illustrated, the structure includes multiple basebands, multiple IFFT units, and multiple DACs. An analog signal converted via a first DAC is mixed with L1 (i.e., a first intermediate frequency (IF1)) by a first mixer. The mixed signal is combined with an analog signal converted via a second DAC by a combiner. The combined signal is combined with L2 (i.e., a second intermediate frequency (IF2)), then is amplified by a PA, and then is transmitted via one antenna through an RF filter.

FIG. 4(c) shows another structure of a transmitter supporting both the intra-band contiguous CA and the intra-band non-contiguous CA. Unlike FIG. 4(b), an analog signal converted via a first DAC is mixed with L1 (i.e., a first intermediate frequency (IF1)) by a first mixer, and the analog signal converted by a second DAC is combined with L2 (i.e., a second intermediate frequency (IF2)). Thereafter, signals combined respectively by the first and second mixers are combined by a combiner, then are amplified by a PA, and then are transmitted via one antenna through an RF filter.

FIG. 4(d) shows a structure of a transmitter supporting both the intra-band contiguous CA and the intra-band non-contiguous CA and occasionally supporting the intra-band CA. Unlike the transceiver of FIG. 4(c), the transceiver performs transmission through one or multiple RF filters and antennas.

Meanwhile, according to the aforementioned intra-band CA, discontinuous resource blocks are allocated to a UE. In addition thereto, a clustered DFT-S-OFDM scheme newly proposed uses one DFT block and allows allocation of non-contiguous subcarriers. Accordingly, simultaneous transmission is newly allowed between physical uplink control channel (PUCCH)-physical uplink shared channel (PUSCH) or between PUSCH-PUSCH. Therefore, a frequency diversity gain can be obtained. In particular, by allowing simultaneous transmission between PUCCH-PUSCH, which was impossible in the conventional method, flexibility and efficiency improvement can be obtained in data scheduling of a BS.

As such, when allocating a discontinuous resource block (RB), a set of continuous RBs is generally called a cluster.

Although the discontinuous RB allocation can obtain a gain based on frequency diversity and a gain based on scheduling flexibility and efficiency improvement, there are many problems due to intermodulation (IM) in terms of unwanted emission including spurious emission (SE) or spectrum emission mask (SEM).

As described above, there is a need to backoff, that is, to decrease Tx power of the UE in terms of unwanted emission.

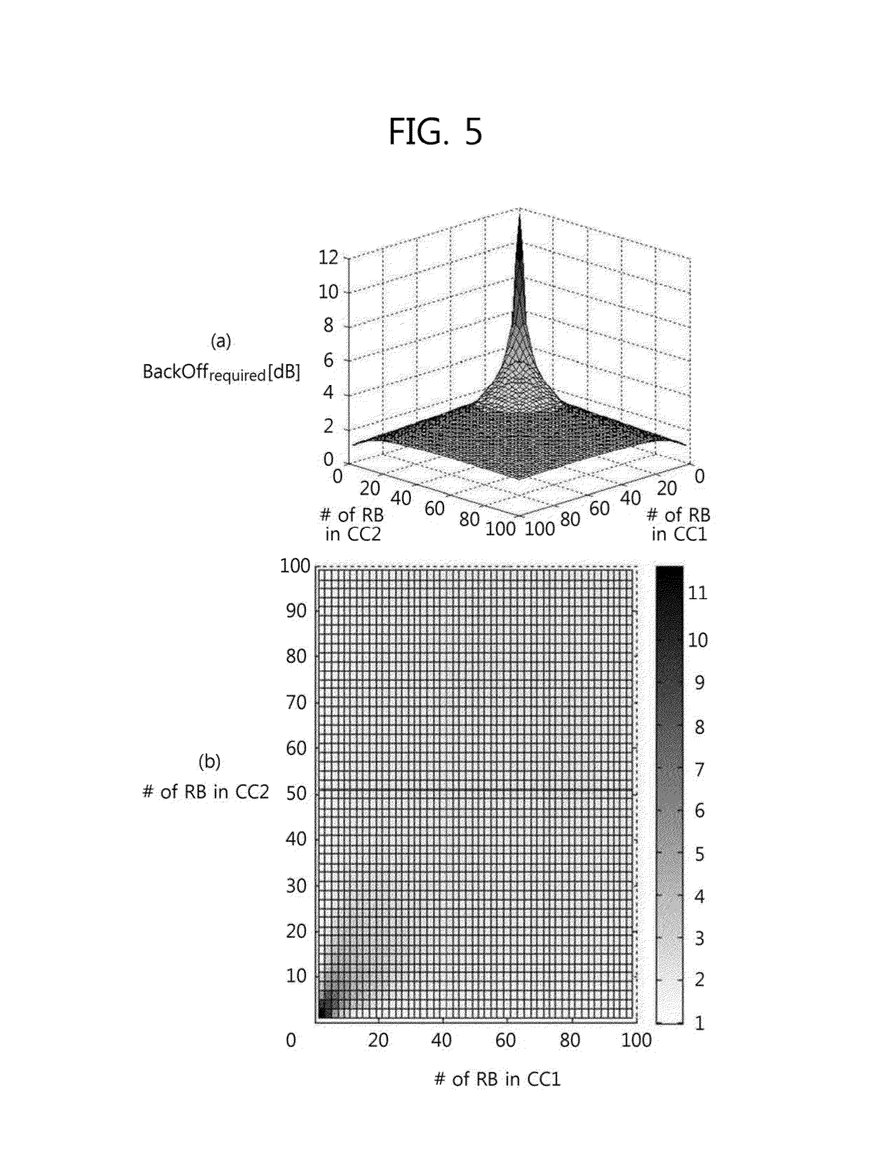

FIG. 5 shows a level of required power backoff in a unit of dB according to 2 cluster RB allocation in 2×20 MHz LTE-A intra-band CA.

In FIG. 5, RB allocation is performed by increasing the number of components carriers (CCs) starting from both ends of each CC. In addition, the required power backoff is BO_{required}, i.e., power backoff required to satisfy all of requirements (i.e., ACLR_{UTRA1/2}, 2×20 MHz SEM, SE) discussed in the LTE-A specification.

According to the discontinuous RB allocation of FIG. 5, LTE-A may require high power backoff greater than 10 dB in the worst case.

That is, as shown in FIG. 5(a), when allocating inner RBs, that is, RBs each of which is directed toward a first RB, a maximum level of backoff is required. In addition, in FIG. 5(b), a horizontal axis denotes a first carrier component, i.e., CC1, and a vertical axis denotes a second carrier components, i.e., CC2. In a bar graph depicted in the right side, the darker the graph, the higher the level of required backoff. In FIG. 5(b), when first RBs are allocated in the respective CCs, the graph is the darkest, and thus required backoff is greater than or equal to up to 10 dB.

As such, when allocating the discontinuous RB, in order to decrease a UE influence acting on the UE itself or to a neighbor system, required power backoff is greater than or equal to up to 10 dB according to an RB allocation pattern, which causes a decrease in a system's service area and capacity.

Hereinafter, a method of scheduling a resource (e.g., an uplink resource) to a UE by considering the aforementioned power backoff will be described according to embodiments of the present invention.

In a first method, when allocating discontinuous RBs, a length of continuous RBs is limited to be greater than or equal to a specific value in each cluster. For example, if a length of continuous RBs is limited to be greater than or equal to 20 in a cluster, power backoff required to suppress unwanted emission may be only 2.5 dB in all cases. This method is the simplest way and can show a good feature in terms of prevention of unwanted emission.

In another method, by considering a power headroom of a UE, when a BS (e.g., an eNodeB) allocates an uplink resource (i.e., RB) as described above, discontinuous RBs can be allocated in a range in which unwanted emission does not occur.

For clear understanding, this can be summarized as follows.

First, a report message for reporting a power headroom (PH) which indicates available extra power or an amount of residual power of a terminal (or UE), e.g., a power headroom reporting (PHR) message or information, is transmitted to a BS (e.g., eNodeB).

The PHR message or information is for reporting a certain amount of power that can be additionally used by the UE. That is, the PHR message or information implies a difference between maximum Tx power of the UE and a current Tx power of the UE.

The reason of reporting the power headroom to the BS by the UE is to prevent a case in which an amount of a radio resource allocated to a specific UE is beyond capacity of the UE. For example, it is assumed that the UE has a maximum possible Tx power of 10 W, and uses an output of 9 W at present by using a frequency band of 10 MHz. If a frequency band of 20 MHz is allocated to the UE, required power is 9 W×2=18 W. However, since maximum power of the UE is 10 W, if 20 MHz is allocated to the UE, the UE may not be able to use the entire frequency band, or the BS may not be able to properly receive a signal of the UE due to power shortage.

That is, since the PHR message or information is used to prevent an uplink resource from being unnecessarily allocated to a UE of which a PH is not sufficient, overall system capacity can be maximized.

Accordingly, by considering the power headroom of the UE, when the BS (e.g., eNode B) allocates the uplink resource (i.e., RB) as described above, discontinuous RBs can be allocated in a range in which unwanted emission does not occur.

The method above can be implemented in various forms.

In a first form, a pattern of discontinuous RBs is restricted by considering a current power headroom of a UE and BO_{required}, i.e., backoff required in a pattern of an RB to be allocated to the UE.

In another form, if RBs selected to be allocated to the UE among RBs are discontinuous, a level of backoff required in the discontinuous pattern is compared with a power headroom of the UE, and if the level of backoff is greater than the power headroom, other RBs are selected instead of using the currently selected discontinuous RBs.

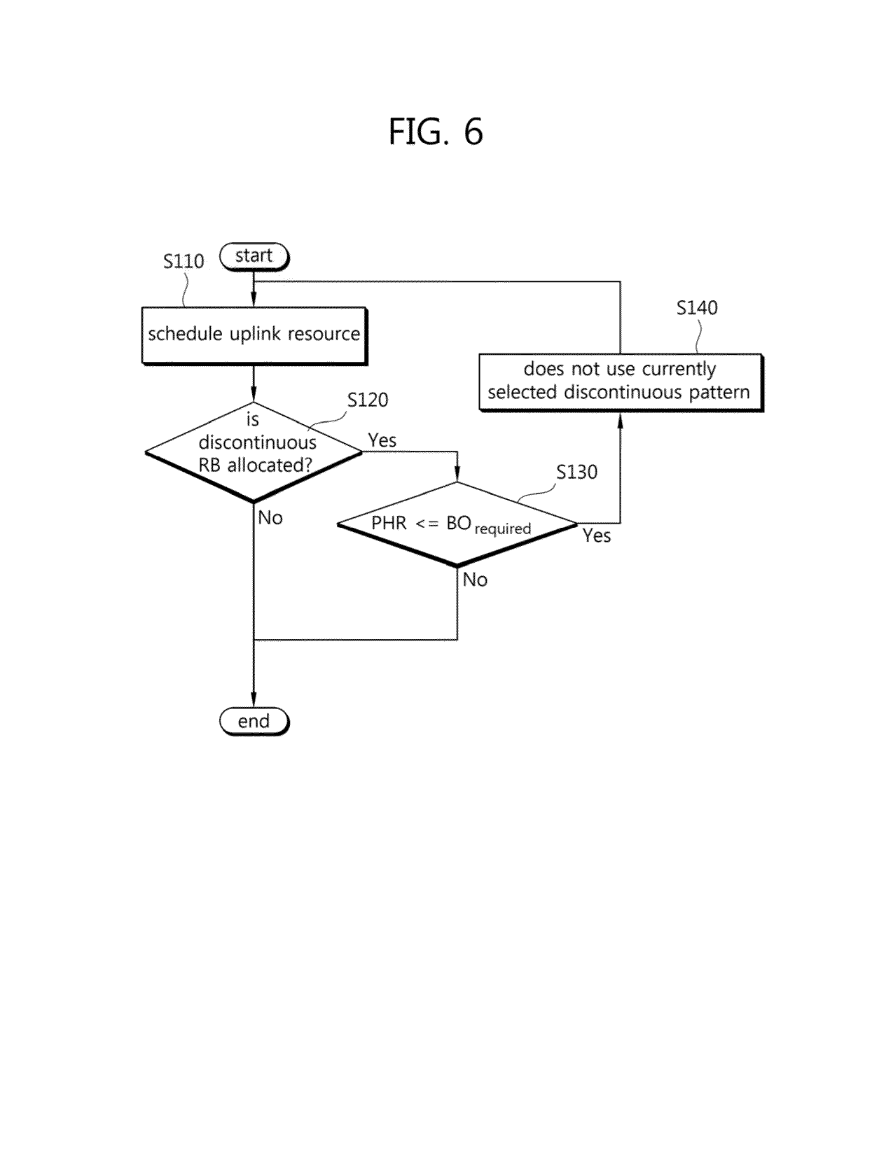

Hereinafter, the above method will be described with reference to FIG. 6.

FIG. 6 is a flowchart showing a scheduling method according to an embodiment of the present invention.

Referring to FIG. 6, a BS or an eNodeB first schedules an uplink resource (step S110). That is, the BS or the eNodeB selects RBs to be allocated to a UE among the remaining unallocated RBs.

Subsequently, it is determined whether the selected RBs are discontinuous (step S120). If the selected RBs are not discontinuous, the selected RBs are allocated to the UE, and then the procedure of FIG. 6 ends.

Otherwise, if the selected RBs are discontinuous, a power headroom of the UE is compared with a power backoff value required by the discontinuous RBs on the basis of a PHR message or information received from the UE (step S130).

If the power backoff value required by the discontinuous RBs is greater than or equal to the power headroom of the UE, the selected discontinuous RBs are not used (step S140), and the procedure returns to step S110 to select other RBs.

Accordingly, since the UE needs to perform transmission always by using RBs requiring power backoff less than a current power headroom, it is possible to suppress occurrence of unwanted emission outside a band.

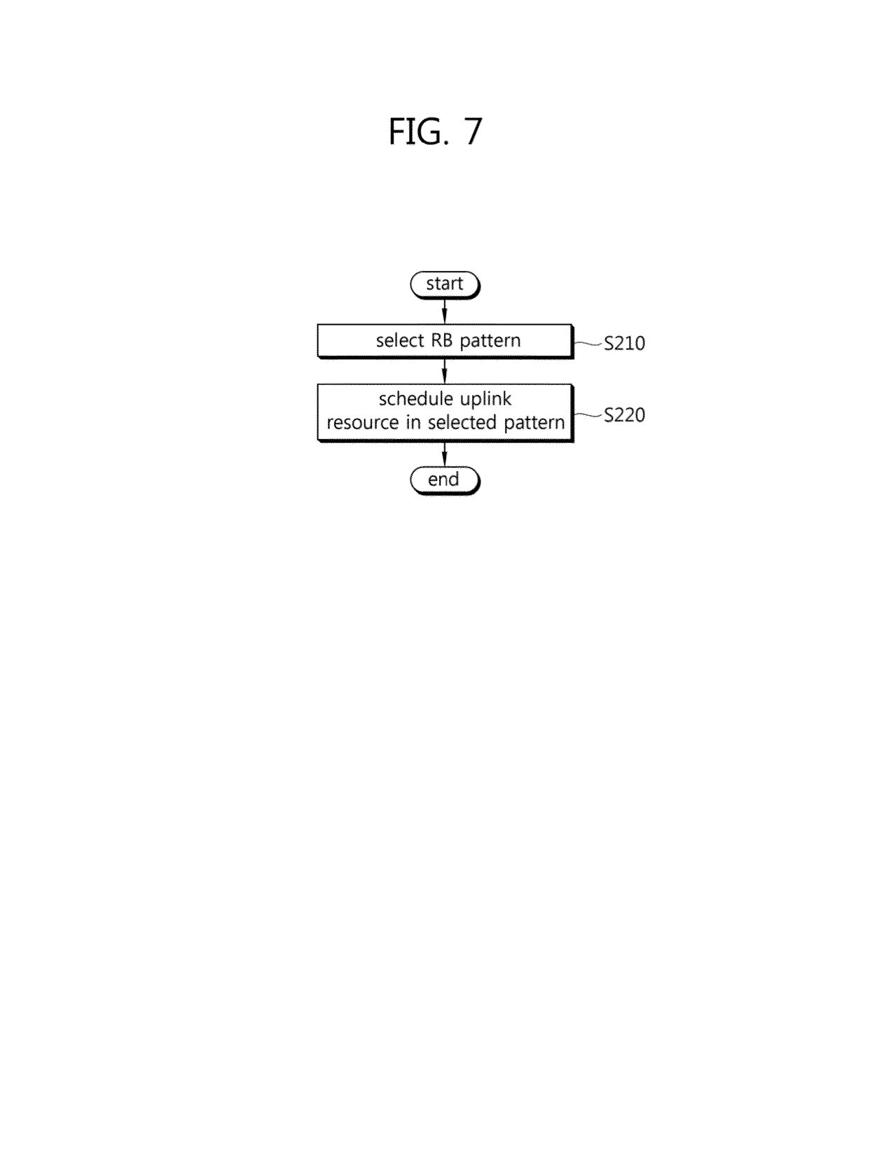

FIG. 7 is a flowchart showing a scheduling method according to another embodiment of the present invention.

The scheduling method of FIG. 7 allows to select, in advance, only RBs requiring power backoff less than a power headroom of a UE when selecting RBs to be allocated to the UE.

More specifically, after receiving a power headroom report from the UE, discontinuous RBs to be allocated to the UE can be selected from among the remaining unallocated RBs on the basis of the power headroom report (step S210).

Subsequently, the selected discontinuous RBs can be allocated to the UE (step S220).

This method has an advantage in that a procedure can be more simplified because only RBs requiring power backoff less than the power headroom of the UE are selected in advance ever since RBs to be allocated to the UE are selected from among the remaining RBs.

In particular, when scheduling an uplink resource in a conventional manner, scheduling is performed to satisfy quality of service (QoS) required by a UE in a cell while optimizing a data transfer rate in consideration of various parameters including channel quality, an amount of effective resources, etc. Therefore, it can be achieved by simply adding the PHR to the parameters.

In addition, when selecting the RBs, a pattern of RBs having the highest gain in terms of frequency diversity or scheduling efficiency can be additionally considered to further increase a system gain.

Meanwhile, BO_{required}, i.e., a power backoff level required due to discontinuous RBs, can be implemented in advance in a loop-up table form. A look-up table considering RF characteristics is shown in FIG. 5.

In general, since the PHR can be defined in an interval of 1 dB, a resolution of a power backoff (i.e., BO_{required}) value can also be expressed in an interval of 1 dB.

TABLE 2

| | | BO_{required} | | | BO_{required} |
|---|---|---|---|---|---|
| L_CRBₘᵢₙ¹ | RBₜₒₜₐₗ² | (dB) | L_CRBₘᵢₙ | RBₜₒₜₐₗ | (dB) |
| 1 | 2 | 12 | 4 | 8 | 5 |
| | 3 | 9 | | 9 | 4 |
| | 4 | 5 | | 10 | 3 |
| | 5 | 3 | 5 | 10 | 4 |
| 2 | 4 | 9 | | 11 | 3 |
| | 5 | 8 | 6 | 12 | 4 |
| | 6 | 5 | | 13 | 3 |
| | 7 | 4 | 7 | 14 | 4 |
| | 8 | 3 | | 15 | 3 |
| 3 | 6 | 7 | 8 | 16 | 3 |
| | 7 | 6 | 9 | 18 | 3 |
| | 8 | 5 | 10 | 20 | 3 |
| | 9 | 4 | 11 | 22 | 3 |
| | 10 | 3 | 12 | 24 | 3 |

¹minimum continues RB length of clustered RB allocation
²total number of allocated RB

A pattern of RBs shown herein is a case of requesting a greatest power backoff (i.e., BO_{required}) value at 2×20 MHz as a value calculated for a case in which an RB size is increased starting from both edges in an allocated bandwidth. Therefore, there is a case in which only power backoff less than the value of Table 1 is requested according to a start position (i.e., RBstart) of a cluster.

Meanwhile, the method described up to now can be stored in a storage medium, and can be executed by a controller.

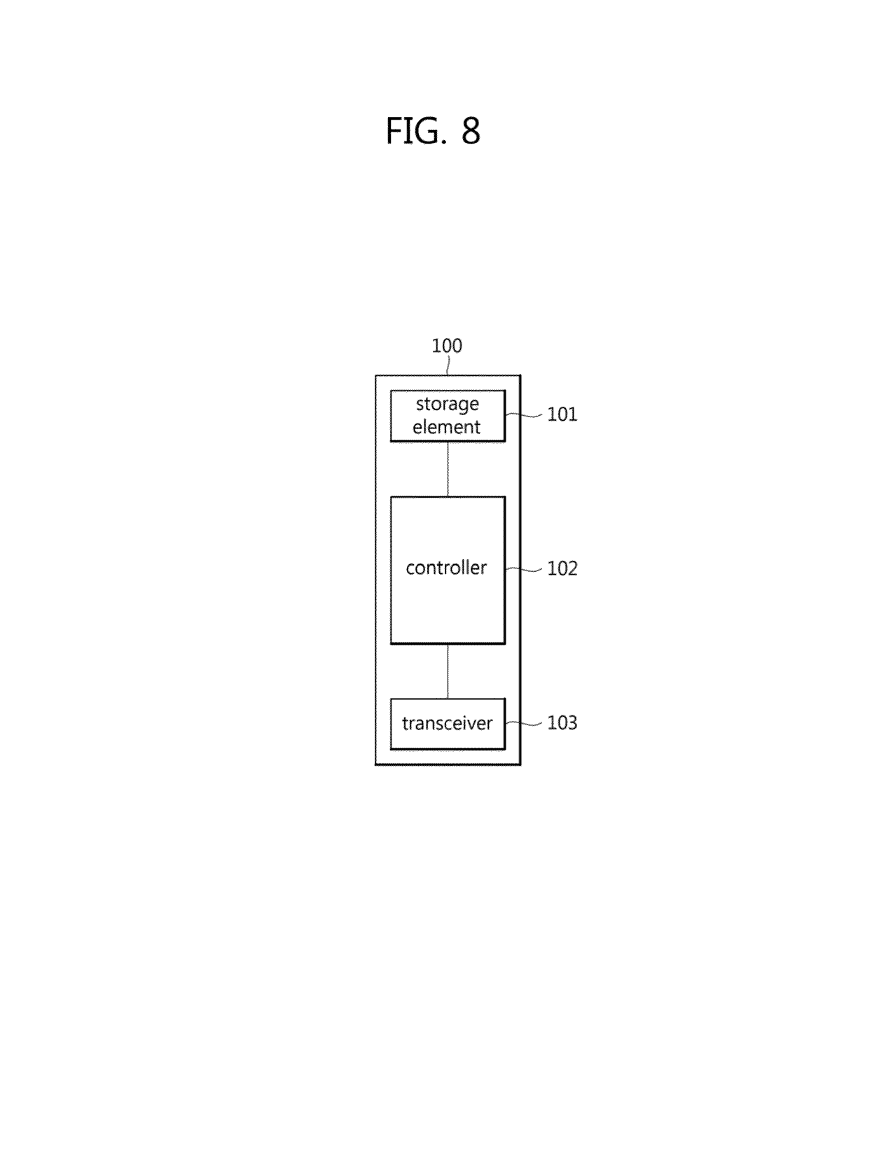

Referring to FIG. 8, a BS 100 includes a storage element 101, a controller 102, and a transceiver 103.

The storage element 101 stores the aforementioned methods.

The controller 102 controls the storage element 101 and the transceiver 103. More specifically, the controller 102 performs each of the aforementioned methods stored in the storage element 101.

Although exemplary embodiments of the present invention have been described above, the scope of the present invention is not limited to the specific embodiments and the present invention may be modified, changed, or improved in various ways within the scope of the present invention and the category of the claims.

1. A scheduling method for allocating a discontinuous resource to a user equipment by using carrier aggregation, comprising:
receiving a power headroom report from the user equipment;
determining discontinuous resource blocks to be allocated to the user equipment on the basis of the power headroom report among the remaining unallocated resource blocks, wherein the determined discontinuous resource blocks suppress occurrence of unnecessary emission; and
allocating the determined discontinuous resource blocks to the user equipment.

2. The scheduling method of claim 1, wherein the determined discontinuous resource blocks are located across a first band and a second band.

3. The scheduling method of claim 2, wherein the first band and the second band are intra-bands.

4. The scheduling method of claim 1, wherein in the determining of the discontinuous resource blocks, BO_{required} for using the discontinuous resource blocks is compared with a power headroom of the user equipment.

5. The scheduling method of claim 1, wherein in the determining of the discontinuous resource blocks, a power headroom of the user equipment is compared with an amount of power to be decreased to prevent occurrence of unwanted emission when the user equipment performs transmission by using the discontinuous resource blocks.

6. The scheduling method of claim 1, wherein the determined resource blocks are resource blocks of which an amount of power to be decreased to prevent occurrence of unwanted power is less than a power headroom of the user equipment.

7. The scheduling method of claim 5, wherein the amount of power to be decreased differs depending on the number of the discontinuous resource blocks.

8. The scheduling method of claim 7, wherein in the determining of the discontinuous resource blocks, a table is used in which the amount of power to be decreased is expressed differently according to the number of the discontinuous resource blocks.

9. A scheduling method for allocating a discontinuous resource by using carrier aggregation, comprising:
selecting resource blocks to be allocated to a user equipment from among the remaining unallocated resource blocks;
determining whether the selected resource blocks are discontinuous;
if the selected resource blocks are discontinuous, determining whether the selected discontinuous resource blocks are suitable for the user equipment on the basis of a power headroom reported from the user equipment; and
if it is determined that the selected discontinuous resource blocks are suitable for the user equipment, allocating the selected discontinuous resource blocks to the user equipment.

10. The scheduling method of claim 9, wherein in the determining whether the selected discontinuous resource blocks are suitable for the user equipment, if the resource blocks are discontinuous, an amount of power to be decreased to prevent occurrence of unwanted emission when the user equipment performs transmission by using the discontinuous resource blocks is compared with the power headroom reported from the user equipment.

11. The scheduling method of claim 9, wherein the determined discontinuous resource blocks are located across a first band and a second band.

12. The scheduling method of claim 11, wherein the first band and the second band are intra-bands.
